(19) United States
(12) Patent Application Publication
(10) Pub. No.: US 2011/0139015 A1
(43) Pub. Date: Jun. 16, 2011

(54) Frying pan with a long handle

(76) Inventor: Bettina Haller, Ludwigsburg (DE)

(21) Appl. No.: 12/927,191

(22) Filed: Nov. 9, 2010

(30) Foreign Application Priority Data
Nov. 11, 2009 (DE) 10 2009 052 528.9
Mar. 15, 2010 (DE) 202009017827.7
Mar. 16, 2010 (DK) PA 2010 00211
Mar. 20, 2010 (CH) 00465/10
Apr. 30, 2010 (CN) 201020189307.8

(51) Int. Cl. A47J 37/10

(52) U.S. Cl. 99/422

(57) ABSTRACT

Frying pan with elongated handle with a weight at the end of the elongated handle of the frying pan for compensating a torque generated by the gravity generated weight of the frying pan.

### BACKGROUND OF THE INVENTION

(1) Field of the Invention

Frying pans for kitchens of households and restaurant operations are mostly furnished as pans with a long handle. The proper pan is a flat dish (1), which is heated. The pan is held at the handle (2) of the pan, wherein the handle (2) of the pan is attached at the pan for this purpose and in fact in such a way that the handle (2) projects about horizontally from the standing pan.

(2) Description of Related Art Including Information Disclosure Under 37 CFR 1.97 and 1.98

The construction of the long handle of the pan according to the state of the art corresponds to this function of the long handle of the pan. The material out of which the long handle is furnished is to assure a sufficient stability, however at the same time a sufficient heat insulation is furnished. The long handle is made frequently out of wood, later out of plastic in additional embodiments. In most cases however, the long handle is a metal tube which can be covered with plastics for a better heat insulation and better gripping. In general, the weight proper is undefined. If the weight is considered at all, it is kept low, wherein reasons based on the cost, that is relating to a saving of material, are more important as the weight saving as such.

The holding of the frying pan at the long handle is perceived as stressful. This is in particular the case where the pan with the long handle is held with the hands over a longer time period and is moved, for example swiveled. An object of the invention is a frying pan with a long handle, wherein the free holding at the long handle is perceived as less stressful as with frying pans with long handle according to the state of the art.

### BRIEF SUMMARY OF THE INVENTION

1. Purposes of the Invention

This object is resolved by having the long handle of the pan loaded (FIG. 1) at the free end with a weight (3). In fact this increases the proper weight of the frying pan with long handle overall. The weight of the frying pan with long handle however is not that weight, which the user feels when the user holds the pan at the long handle. Instead, the user feels a torque.

### BRIEF DESCRIPTION OF THE SEVERAL VIEWS OF THE DRAWINGS

FIG. 1 shows a right side perspective view of the frying pan with a long handle loaded at the free end with a screw weight,

FIG. 2 shows a right side perspective view of the frying pan with a long handle with the enlarged screw weight loaded at the free end,

FIG. 3. shows a right side perspective view of the frying pan with a long handle and a cylinder out of metal, furnished with a thread at the cylinder jacket, and a counter thread disposed at the free end of the handle,

FIG. 4. shows a right side perspective view of the frying pan with a long handle and the screw weight subdivided into two cylindrical discs of the same diameter having thread at the cylinder jacket which can be screwed at the end of the elongated handle,

FIG. 5. shows a right side perspective view of the frying pan furnished at the long handle as a tube filled with a heavy material.

### DETAILED DESCRIPTION OF THE INVENTION

The torque is the product out of the force, which corresponds to the proper weight of the pan, and force arm, that is the distance between hand and center of gravity. In general, the center of gravity of the filled pan is disposed in the middle of the pan itself. Relative to the proper weight of the pan and its filling, the weight proper of the long handle is so low that it does not lead to a substantial shift of the center of gravity from the middle of the pan out in the direction of the long handle.

This torque loads and charges the user of the frying pan with a long handle substantially more as the pure proper weight. While the proper weight is received with the muscles of the arm of the user, the user has to accept the torque in such a way that the user furnishes the corresponding, opposite torque with the hand wrist.

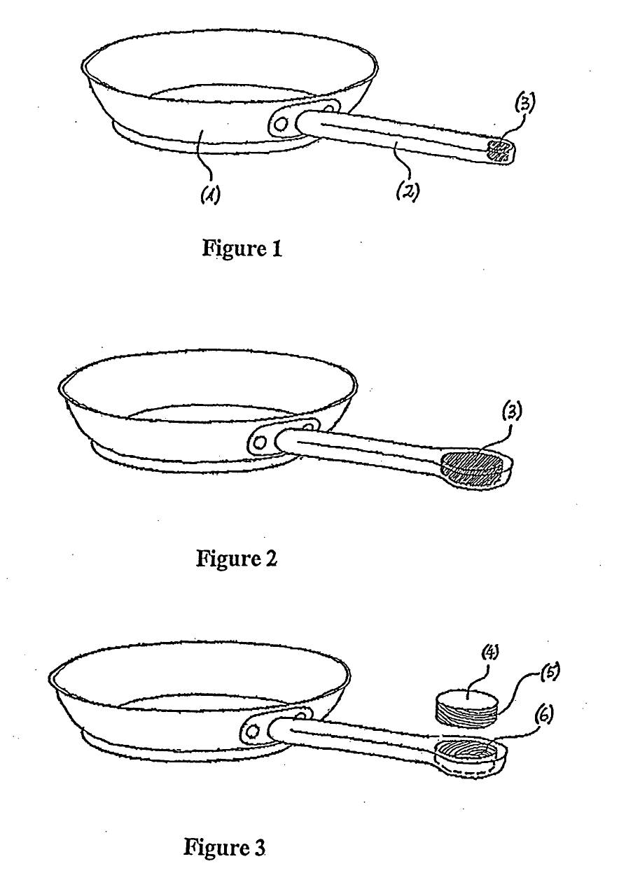

The force arm is shortened and therewith the torque is decreased (FIG. 1) by weight loading the end of the long handle of the pan as is taught according to the present invention.

The weight which can be applied at the end of the long handle is in a way limited by the dimensions of the long handle of the frying pan. It is taught as a preferred embodiment in this context to expand (FIG. 2) the breadth of the long handle of the frying pan at its end.

The weight is furnished as a cylinder out of metal (4) as a preferred embodiment, wherein the embodiment is furnished with a thread (5) at the cylinder jacket, wherein the thread (5) can be screwed into a counter thread (6) disposed at the free end of the long handle—called in the following: “screw weight” (FIG. 3).

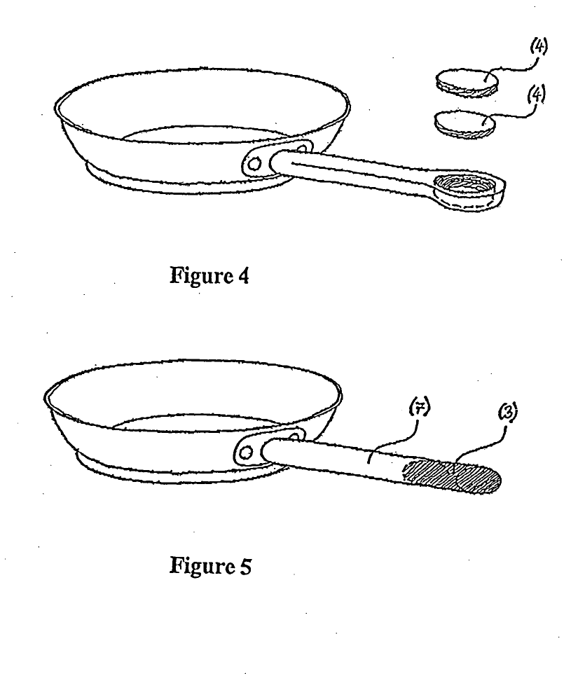

A still more precise taring is made possible by the following embodiment: the screw weight is subdivided into several cylindrical discs of the same diameter, wherein the cylindrical discs having each case the thread at the cylinder jacket (FIG. 4). The user can tare the weight with a number of these discs, and the user screws these disks in at the end of the elongated handle.

As an addition or also as an alternative to the recited embodiment, the frying pan is furnished for the purpose of an increase in weight at the long handle of the pan as a tube (7), which is there filled with a heavy material, preferably metal—“filling weight” (FIG. 5). For this purpose, several different embodiments can be considered:

if a material is used for the weight, which material becomes liquid already at low temperatures as for example lead, the tube at the end of the long handle of the pan can be cast with this material. Also a weight piece out of cast iron can be considered, wherein the cast iron is inserted from the end into the tube and is attached in a suitable way for example by gluing. A cross-section is favorable for this fit piece wherein the cross-section narrows toward the pan with the consequence that a certain strength of the connection already is generated with the fitting, which can be correspondingly given to the tube at the end of the pan.

It is recommended as a preferred embodiment to combine the filling weight with the screw weight in such a way that an inner thread is cut into filling weight, wherein the inner thread corresponds to the outer thread of the screw weight. This embodiment allows the user to use the screw weight as a taring weight. According to the user's choice, the taring weight can be dispensed with or can be screwed in and in this manner regulate the total weight at the end of the handle.

The long handle of the pan is not longer than the diameter of the pan in commercially available pans with handle. The torque of the weight and therewith the effectiveness of the pans according to the present invention is thereby improved by having the long handle of the pan more elongated.

The torque of the weight is also improved by having the weight made out of a material with a high specific weight. Preferably tungsten is proposed as such a material.

1. Frying pan with a long handle characterized in that the long handle (2) of the frying pan exhibits a weight (3) at its free end.

2. Frying pan with a long handle according to claim 1 wherein the breadth of the long handle of the pan is larger at the free end of the long handle as in the middle of the long handle.

3. Frying pan with a long handle according to claim 1, wherein the weight is a metal cylinder (4) with an outer thread (5) at the cylinder jacket and a fitting cylindrical recess with a fitting inner thread (6) at the cylinder jacket is furnished at the end of the long handle.

4. Frying pan with a long handle according to claim 3, wherein the weight is subdivided into several cylindrical discs of the equal diameter, wherein the discs in each case have the outer thread (5) at the cylinder jacket.

5. Frying pan with a long handle according to claim 1, wherein the long handle of the frying pan is a tube (7) at the end and wherein the weight (3) is fitted into the tube (7).

6. Frying pan with a long handle according to claim 3, wherein the weight exhibits a recess with inner thread and in addition a weight and wherein the long handle of the frying pan is a tube (7) at the end and wherein the weight (3) is fitted into the tube (7).

7. Frying pan with a long handle according to claim 1, wherein the long handle is longer than the diameter of the frying pan.

8. Frying pan with a long handle according to claim 1, wherein the weight is made out of tungsten.
